(19) United States
(12) Patent Application Publication
(10) Pub. No.: US 2026/0312357 A1
(43) Pub. Date: Oct. 8, 2026

(54) DYNAMIC REPETITION-RATE CONTROL OF SINGLE-CAVITY DUAL-COMB LASERS

(71) Applicant: THE REGENTS OF THE UNIVERSITY OF COLORADO, A BODY CORPORATE, Denver, CO (US)

(72) Inventors: SHU-WEI HUANG, Broomfield (CO); BOWEN LI, Boulder, CO (US); NEERAJ PRAKASH, Boulder, CO (US)

(21) Appl. No.: 19/481,788

(22) PCT Filed: May 5, 2024
(86) PCT No.: PCT/US2024/027904

§ 371 Date: Nov. 5, 2025

Related U.S. Application Data
(60) Provisional application No. 63/464,450, filed on May 5, 2023.

(51) Int. Cl. H01S 3/091; H01S 3/094

(52) U.S. Cl. CPC H01S 3/0912; H01S 3/094011

(57) ABSTRACT

A method for dynamic repetition-rate control of a single-cavity dual-comb laser (SCDCL) includes controlling the SCDCL such that a repetition-rate difference between first and second pulse trains generated by the SCDCL has a positive value, recording an interferogram with the first and second pulse trains while the repetition-rate difference has the positive value, and controlling, after said recording, the SCDCL such that the repetition-rate difference between the first and second pulse trains has a negative value. The first and second pulse trains accrue a first temporal offset while the repetition-rate difference has the positive value. The first and second pulse trains accrue a second temporal offset while the repetition-rate difference has the negative value. The first temporal offset and the second temporal offset have the same magnitude and opposite signs.

### RELATED APPLICATIONS

This application claims priority to U.S. Provisional Patent Application No. 63/464,450, filed May 5, 2023, which is incorporated herein by reference in its entirety.

### BACKGROUND

Single-cavity dual-comb lasers (SCDCLs) generate two frequency combs with slightly different repetition rates from a single laser cavity. The two frequency combs maintain high mutual coherence even under free-running conditions. This feature enables practical dual-comb metrology systems by eliminating complex mutual-comb-locking electronics, thus significantly enhancing system compactness. As a result, dual-comb metrology using SCDCLs has been widely demonstrated for various applications, including LIDAR, gas sensing, pump-probe spectroscopy, and bio-imaging. Fueled by these application prospects, SCDCLs have been intensively studied in various laser platforms, including on-chip microresonators, Kerr-lens mode-locked lasers, semiconductor lasers, and fiber lasers. Fiber SCDCLs are a particularly attractive architecture due to their compactness and environmental robustness.

### SUMMARY

Recently, the inventors demonstrated the first counter-propagating all-normal dispersion (CANDi) fiber laser that broke through the long-sought-after energy limit in conventional fiber-based single-cavity dual-comb lasers (SCDCLs). Using all-normal dispersion fibers and nonlinear polarization rotation (NPR) based mode-locking, 8-nJ pulse energies were achieved in both directions, which is two orders of magnitude higher than the previous state-of-the-art bidirectional mode-locked fiber lasers. In addition, the single-cavity configuration results in very small repetition rate difference (Δfᵣₑₚ) that is typically smaller than 100 Hz, which leads to ultra-fine (i.e., a few fs) temporal dual-comb walk-off step size. Both features are particularly beneficial for nonlinear dual-comb applications such as pump-probe spectroscopy, which enhance the sensitivity and precision, respectively.

However, the small Δfᵣₑₚ also limits the dual-comb detection frame rate and renders the detection results more prone to low-frequency noises. Moreover, the single-cavity configuration eliminates the possibility of flexible Δfᵣₑₚ tuning using conventional methods such as cavity length control. As a result, it is challenging for prior-art CANDi laser architectures to be adopted for nonlinear dual-comb applications.

The present embodiments include a dynamic Δfᵣₑₚ modulation technique in SCDCLs that advantageously breaks the trade-off between the temporal resolution and detection frame rate. By modulating the pump power with a square-wave waveform, Δfᵣₑₚ can be dynamically switched between a first frequency (e.g., +10 Hz) and a second frequency (e.g., −10 Hz) at a rate of 4 kHz. This is achieved thanks to the unique non-reciprocal gain dispersion in the bidirectional mode-locking configuration, which makes the center-wavelength-shifting to respond differently to the pump power. Combined with the inherent near-zero Δfᵣₑₚ and the large intra-cavity group-delay dispersion, Δfᵣₑₚ is dynamically tuned across zero using the present embodiments. This allows the two combs pulses to temporally scan across each other back and forth without needing to walk off for a whole round-trip, which significantly increase the dual-comb detection frame-rate without sacrificing the temporal sampling rate. Therefore, the dynamic CANDi (DCANDi) method of the present embodiments effectively mimics a high-repetition-rate dual-comb system, but maintains the high pulse energy and high temporal resolution essential for precise nonlinear dual-comb applications.

The present embodiments solve the problems of small repetition rates in CANDi lasers, making them promising tools for next-generation nonlinear dual-comb metrology. Moreover, the principle is generally applicable to other SCDCL platforms where gain-dispersion dominates the repetition rate difference, thus representing a general solution for frame-rate enhancement in SCDCL-based dual-comb systems. For example, the present embodiments may be used with other types of fiber lasers, solid-state lasers, and dual-comb systems based on microresonators.

### BRIEF DESCRIPTION OF THE FIGURES

FIG. 1A shows a simplified experimental setup for dynamically modulating the repetition-rate difference Δfᵣₑₚ of two frequency combs generated by a counterpropagating all-normal dispersion (CANDi) laser, or DCANDi, in embodiments.

FIG. 1B illustrates: (Top) Δfᵣₑₚ modulation of the CANDi laser of FIG. 1A, (Middle) temporal walk-off of the two frequency combs under modulation of Δfᵣₑₚ, and (Bottom) enhancement of an interferogram repetition rate under modulation of Δfᵣₑₚ.

FIGS. 2A and 2B illustrate DCANDi simulation routine results.

FIGS. 3A-3G illustrate the basic performance of DCANDi.

FIG. 4A illustrates evolution of the spectral shift δω_{Δ}.

FIG. 4B illustrates evolution of Δfᵣₑₚ due to intracavity group delay dispersion β₂ coupled with the spectral shift δω_{Δ}.

FIGS. 5A-5E illustrate precise characterization of dual-comb time-delay evolution during dynamic modulation of Δfᵣₑₚ.

FIGS. 6A-6E illustrate measurements of the relaxation time constant of a semiconductor saturable absorber mirror (SESAM).

FIG. 7A illustrates the response of Δfᵣₑₚ to changes in Pump2 power.

FIG. 7B illustrates changes in output power versus changes in Pump2 power.

FIG. 8A illustrates modulation of pump power by a 1-kHz square wave.

FIG. 8B illustrates modulation of pump power by a 5-kHz square wave.

FIG. 9A shows an experimental setup for triggering the CANDi laser of FIG. 1A with an interferogram.

FIG. 9B illustrates triggering the CANDi laser of FIG. 1A with an interferogram.

FIG. 10 shows how a double pulse train is formed by combining first and second optical pulse trains generated by respective first and second optical frequency combs.

FIG. 11 shows one example of an interferogram obtained from a photodetector.

FIG. 12 is a flowchart of a method for dynamic repetition-rate control of a single-cavity dual-comb laser, in embodiments.

### DETAILED DESCRIPTION

### 1. Introduction

Ultrafast pump-probe measurements play a pivotal role in the study of femtosecond light-matter interaction and carrier dynamics as well as the characterization of chemical, solid-state, and biological materials [1]. Among its many variants, the dual-comb pump-probe technique offers a unique non-mechanical delay-scanning mechanism that solves the measurement speed bottleneck and enables high-speed applications. These applications include, but are not limited to, THz time-domain spectroscopy [2-4], ultrafast photoacoustic characterization [5, 6], high-sensitivity photothermal spectroscopy [7], multidimensional coherent spectroscopy [8, 9], coherent Raman spectroscopy [10-13], asynchronous optical sampling and dual-comb laser ranging (LiDAR). In the dual-comb pump-probe technique, delay scanning is controlled by setting the repetition-rate difference Δfᵣₑₚ between the two combs such that the two pulse trains temporally walk off each other in steps of

$$Δ {f}_{rep} / {f}_{rep}^{2} ,$$

where fᵣₑₚ is the average repetition rate of the two combs. The total delay scan is 1/fᵣₑₚ and the measurement speed is limited by 1/Δfᵣₑₚ.

Single-cavity dual-comb lasers (SCDCLs) have been studied over the past few years in various laser platforms, including on-chip microresonators [14], Kerr-lens mode-locked lasers [15], semiconductor disk lasers [16], and fiber lasers [17-22]. Of these, fiber SCDCLs are particularly attractive because of their compactness and environmental robustness. Fiber SCDCLs open up new possibilities for low-complexity dual-comb systems and may potentially lead to a paradigm shift in dual-comb light-source development [23, 24].

Recently, the inventors demonstrated the counter-propagating all-normal dispersion (CANDi) fiber laser that broke the energy limit in fiber SCDCLs [25, 26]; in this work, 8-nJ pulse energies were achieved in both clockwise (CW) and counterclockwise (CCW) directions, two orders of magnitude higher than the previous state-of-the art. A compressed pulse duration of 190 fs and an integrated relative timing jitter of 39 fs (1 kHz, 20 MHz) were also demonstrated and characterized. All these features make the CANDi fiber laser an ideal source candidate for ultrafast dual-comb pump-probe measurements.

Another obstacle to widespread adoption of dual-comb pump-probe techniques is the fundamental trade-off between the time resolution and measurement speed, which arises because of their opposite scaling laws with respect to Δfᵣₑₚ [27]. In addition, for applications such as coherent Raman spectroscopy, where the vibrational coherence lifetime of most molecules are only a few picoseconds, dual-comb pump-probe technique's typical total delay scan of more than 1 ns is much longer than necessary, resulting in a less-than-1% measurement duty cycle and a waste of power that effectively lowers the measurement sensitivity [12]. To break the fundamental trade-off and enhance the time and energy efficiency, a few techniques have been devised recently by non-mechanical cavity length control of one of the dual combs [11, 13, 28]. Impressive results have been demonstrated, including orders-of-magnitude measurement-speed enhancement, without sacrificing resolution and sensitivity, and near-100% duty cycle coherent Raman spectroscopy [11, 13]. However, none of these methods are compatible with the SCDCL architectures, let alone fiber-based SCDCLs.

The present embodiments include methods for all-optical dynamic modulation of Δfᵣₑₚ that may be implemented with SCDCLs to overcome the fundamental trade-off between time resolution and measurement speed. When implemented with a CANDi laser, these methods are referred to here in as dynamic CANDi (DCANDi). A prototype DCANDi setup was constructed and used to illustrate dynamic Δfᵣₑₚ modulation between +10 Hz and −10 Hz at kilohertz-level modulation frequencies. Importantly, the relative timing jitter of the DCANDi setup was found to be similar to that of the CANDi fiber laser itself, confirming that the dynamic modulation of Δfᵣₑₚ does not introduce excessive noise. Furthermore, DCANDi was studied and validated both theoretically and experimentally. As a proof-of-principle experiment, the DCANDi setup was used to measure the relaxation time of a semiconductor saturable absorber mirror (SESAM), achieving a measurement speed and duty cycle enhancement of 143 times compared to traditional dual-comb pump-probe measurements. DCANDi is therefore a promising technique for low-complexity, high-speed, high-sensitivity, ultrafast, dual-comb, pump-probe measurements.

### 2. DCANDi Architecture and Principle

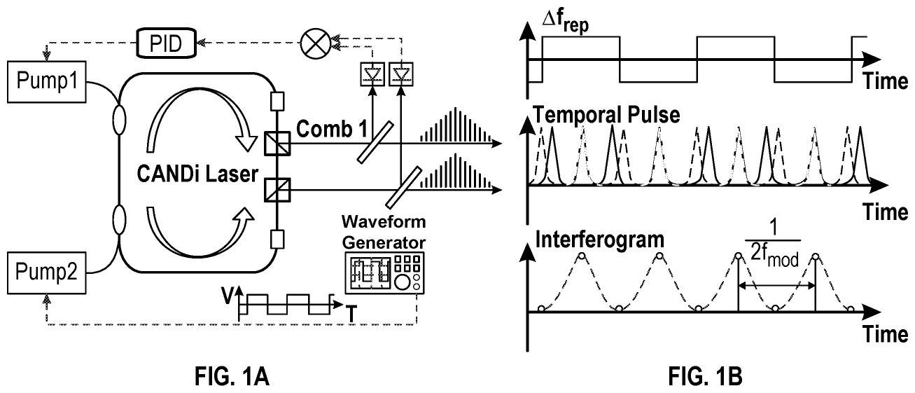

FIG. 1A is a schematic diagram of the DCANDi architecture. This architecture uses a CANDi laser that is similar to that described in Ref. [25]. For the experimental demonstrations presented herein, the gain element of the CANDi laser was a ytterbium-doped fiber (YDF) having a length of approximately two meters and a six-micron core. On either side of the YDF was a one-meter-long segment of HI1060 passive fiber. To bring Δfᵣₑₚ close to zero, the lengths of the two passive fibers were kept the same, making the cavity nearly symmetric for both the CW and CCW directions. Mode locking was achieved using nonlinear polarization rotation. Moreover, the YDF was pumped bidirectionally by two 980-nm laser diodes (labeled “Pump1” and “Pump2” in FIG. 1A) with similar powers to make the gain distribution inside the YDF symmetric for both the CW and CCW directions. In this way, Δfᵣₑₚ was tuned to be near zero by adjusting intracavity waveplates (not shown in FIG. 1A).

Modulating the current of either of the pumps with a square waveform causes the sign of Δfᵣₑₚ to be dynamically flipped, as schematically shown in the top plot of FIG. 1B. As shown in FIG. 1A, this square-wave modulation was applied to Pump2 for the experimental demonstrations described herein. To ensure that the absolute value of Δfᵣₑₚ is the same before and after flipping, a slow phase-locked loop (PLL) with a 100-Hz bandwidth was applied to Pump1 to lock the average value of Δfᵣₑₚ to zero. Since the PLL's bandwidth was much smaller than the modulation frequency (kHz), the PLL did not counteract the square-wave modulation.

With the average value of Δfᵣₑₚ locked to zero, pulses from the two combs temporally walk off each other alternatively as the sign of Δfᵣₑₚ flips (see the middle plot of FIG. 1B) without needing to walk off for a whole round-trip. As a result, the temporal interferogram frequency (i.e., the dual-comb detection frequency) will be twice the modulation frequency, instead of Δfᵣₑₚ as in conventional dual-comb systems. In this way, DCANDi may dramatically increase detection speed without sacrificing temporal sampling resolution and pulse energy, thus providing an ideal tool for high-speed nonlinear dual-comb applications.

### 3. Mechanism of Dynamic Modulation in DCANDi

Changes in pump power induces dynamic tuning of Δfᵣₑₚ, an effect that is mainly attributed to the non-identical center-frequency change coupled with intracavity group delay dispersion (β₂), as identified here through numerical simulation. The dependence of fᵣₑₚ on pump power has been extensively studied in Refs. [25] and [26]. The change in fᵣₑₚ due to change in pump power may arise from several factors including spectral shift (ω_{Δ}) coupled with β₂, change in root mean square spectral width coupled with third-order dispersion, and gain and self-steepening terms. In Ref. [26], the a term coupled with β₂ was identified as the main coupling mechanism, resulting in pump-power-induced fᵣₑₚ and Δfᵣₑₚ changes in the CANDi laser. Considering only this term, changes in fᵣₑₚ and Δfᵣₑₚ induced by the total pump power (P) are governed by the equations

$$\frac{d {f}_{rep}}{dP} = - {f}_{rep}^{2} \times \{ {β}_{2} \frac{d {ω}_{Δ}}{d P} \} \qquad ( 1 )$$

$$\frac{d Δ {f}_{rep}}{d P} = - {f}_{rep}^{2} \times \{ {β}_{2} \frac{d {ω}_{{Δ}_{C W}}}{dP} - {β}_{2} \frac{d {ω}_{{Δ}_{C C W}}}{dP} \} = - {f}_{rep}^{2} \times \{ {β}_{2} \frac{d δ {ω}_{Δ}}{dP} \} , \qquad ( 2 )$$

as explained in Ref. [26]. In these equations, ω_{Δ}_{_{CW}} and ω_{Δ}_{_{CCW}} are the spectral shifts in the CW and CCW directions while δω_{Δ} is the relative spectral shift between these two directions. Since both combs share the same pump, the mechanism for pump-power-induced change on Δfᵣₑₚ can be attributed to the asymmetric response of the two directions to pump power change. When only one of the pumps is modulated, the gain distribution along the length of the YDF becomes asymmetric for the two directions. This results in unequal gain center shift, resulting in different spectral shifts for the two directions for a given pump power change. This causes unequal changes in fᵣₑₚ for the two directions and hence a change in Δfᵣₑₚ.

To confirm this hypothesis, a simulation routine was developed to model DCANDi by solving the generalized complex Ginzburg-Landau equation coupled with rate equations. Since the gain inside the YDF dynamically changes as the pump power is modulated, a requirement of the simulation is to calculate the true gain by solving the rate equations and generalized complex Ginzburg-Landau equation simultaneously. Note that a steady-state condition of upper-state population and a perfect symmetric cavity is assumed in the simulation.

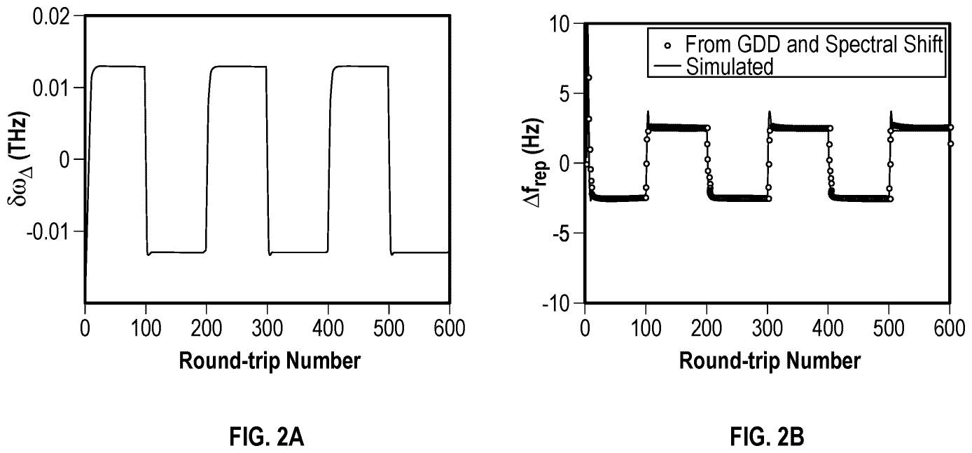

FIGS. 2A and 2B show the simulation results. FIG. 2A illustrates δω_{Δ} as a function of round-trip number for a particular mode-locked state as the pump power is modulated. FIG. 2B compares the simulated Δfᵣₑₚ deduced from the difference in pulse timing and Δfᵣₑₚ calculated from the values in FIG. 2A using Eqn. 2. The simulated Δfᵣₑₚ matches the Δfᵣₑₚ calculated using β₂ coupled with δω_{Δ}. This confirms that unequal gain center shift, resulting in different ω_{Δ} for the two directions for a given pump power change, is the main reason behind dynamic modulation of Δfᵣₑₚ.

### 4. Results and Discussion

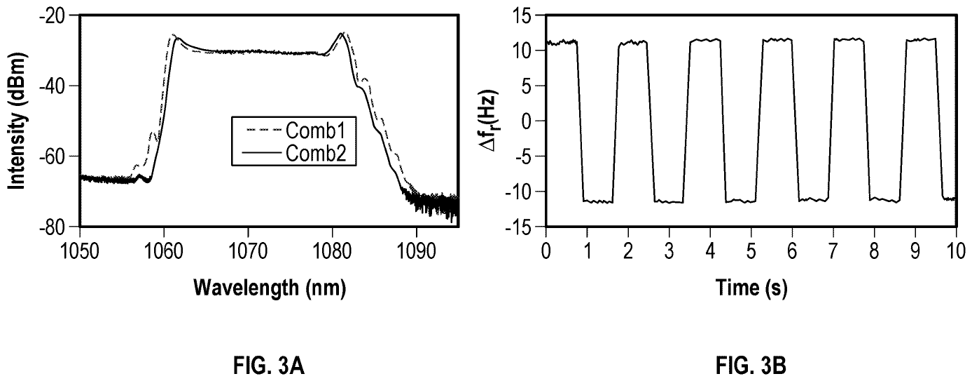

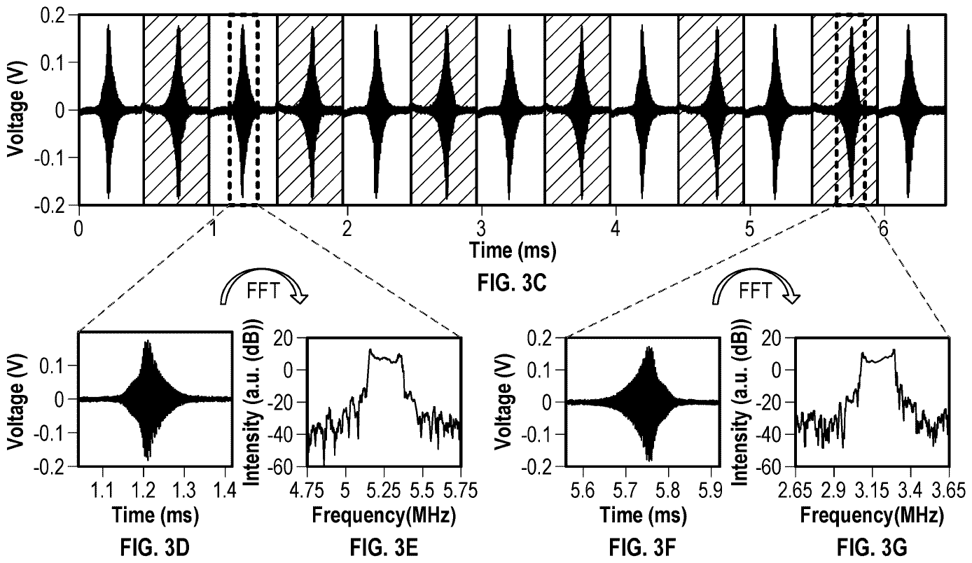

FIGS. 3A-3G show the performance of DCANDi. FIG. 3A shows the optical spectra of the two combs under static state (i.e., no modulation of the pumps). The two spectra show high spectral overlap and both represent a “batman”-type spectrum typical for CANDi lasers. The CANDi laser had a repetition rate of 48 MHz and pulse energies of about 2 nJ for both directions. Higher pulse energies can be obtained by replacing the 6-μ-core fibers with 10-μm-core large mode area fibers [26]. A single pulse compressor made of transmission grating pairs was used to compress pulses from both directions to around 180 fs with total transmission of over 85% (See more details below in Section 8). Therefore, the peak power for the compressed pulses is about 11 kW, high enough to enable many nonlinear dual-comb applications.

To illustrate operation of dynamic Δfᵣₑₚ modulation, the current of Pump2 was modulated at 1 Hz while the repetition rates of both combs were monitored using two frequency counters referenced to the same clock. The corresponding current modulation depth of 3% does not destroy the mode-locking state thanks to the wide mode-locking range of the CANDi laser (and ANDi lasers in general). FIG. 3B shows the resulting measurements of Δfᵣₑₚ, which periodically and deterministically switches from +11 Hz to −11 Hz. The fluctuations in FIG. 3B are due to the limited resolution of the frequency counter under a gate time of 0.03 s.

To demonstrate the potential of dynamic operation of the DCANDi laser, the modulation frequency was then increased to 1 kHz and the PLL was turned on. The two combs were then combined through a 50/50 coupler and launched together into an amplified photodetector. Since the pulses from the two combs do not walk-off monotonically when the average of Δfᵣₑₚ is locked to zero, a variable optical delay line (ODL) was deployed on the path of one comb to make sure the pulses temporally overlap each other at the photodetector. The output of the photodetector was low-pass filtered with a cutoff frequency of 28 MHz; FIG. 3C shows the corresponding temporal waveform. As expected, the temporal interferogram between the two combs shows a repeating frequency of 1 kHz while two interferograms appear in each period, which results from forward and backward (shown shaded) scanning. The time separations between a forward-scanning interferogram and two neighboring backward-scanning interferograms can be tuned to be identical by adjusting the relative delay between the two combs, leading to an effective dual-comb detection speed of 2 kHz. FIGS. 3D and 3F show the zoomed-in temporal waveforms of a forward-scanning and a backward-scanning interferogram, respectively. FIGS. 3E and 3G show their respective spectra, obtained by performing a fast Fourier transform (FFT). The two spectra are located at different center frequencies due to the change of carrier-envelope-offset frequency (Δf_{ceo}) in response to the modulation of pump power. Nevertheless, both FIGS. 3E and 3G show a radio-frequency spectrum that matches well with the overlapping optical spectrum in FIG. 3A, which indicates the feasibility of fast and accurate dual-comb metrology using DCANDi.

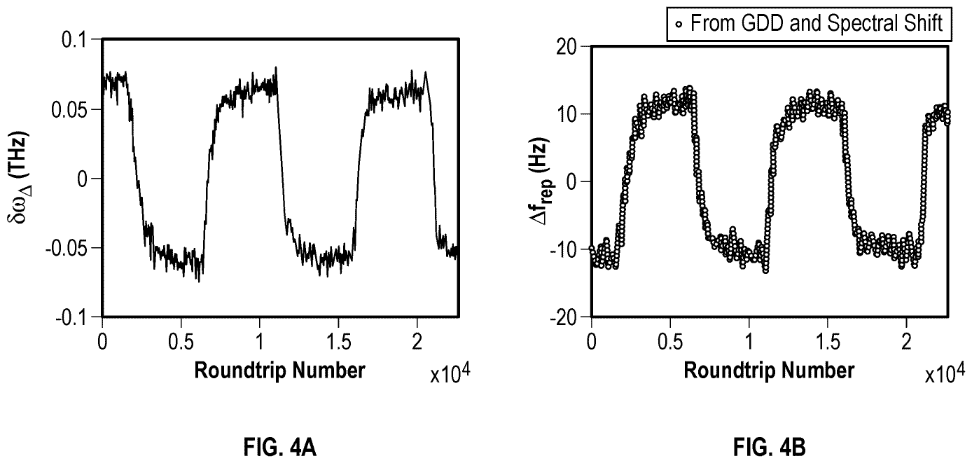

In the previous section, simulations were used to identify the unequal ω_{Δ} in the two directions coupled with β₂ as the main reason behind the dependence of Δfᵣₑₚ on pump power change. This mechanism was experimentally confirmed by measuring the evolution of the pulse spectrum in both directions during the pump power modulation using the dispersive Fourier transform (DFT). The modulation frequency was set to 5 kHz. The values of δω_{Δ} calculated from the DFT measurements are shown in FIG. 4A. FIG. 4B shows the expected Δfᵣₑₚ calculated based on Eqn. 2 and data from FIG. 4A. The β₂ coupled with δω_{Δ} causes Δfᵣₑₚ to change from −11 Hz to +11 Hz. This change matches the magnitude of dynamic modulation in Δfᵣₑₚ achieved experimentally, as shown in the frequency-counter measurements of FIG. 3B. This matching validates the results from the simulation and confirms that the unequal co change due to pump power change contributes the most in dynamic modulation of Δfᵣₑₚ.

The difference in the modulation depth of Δfᵣₑₚ in simulation and experiments is due to the difference in mode-locking states in the experiment and simulation. Also, the simulation assumes a perfectly symmetric cavity, while it could be slightly asymmetric in the real experiments. However, the fact that dynamic modulation can be achieved even in a perfectly symmetric cavity, as shown through simulation results, rules out the necessity of cavity asymmetry (e.g., asymmetry in passive fiber lengths) for creating an unequal response of the two directions to pump power and confirms that spectral shifting plays a major role in this process. Since the disproportionate gain distribution along the length of the YDF in the two directions is the primary cause for realizing the dynamic tunable dual comb presented in this study, such dynamic tuning can be achieved in any symmetric bidirectional SCDCL systems where such an imbalanced longitudinal gain in the gain medium can be achieved. This is another advantage of a bidirectional geometry, as compared to dual-wavelength and dual-polarization SCDCL systems, along with less cross-talk and overlapping spectra. Hence, DCANDi is widely applicable in bidirectional SCDCL geometries such as soliton fiber dual combs, free-space dual combs, etc., and is not limited to CANDi fiber lasers.

### 5. Noise Characterization of DCANDi

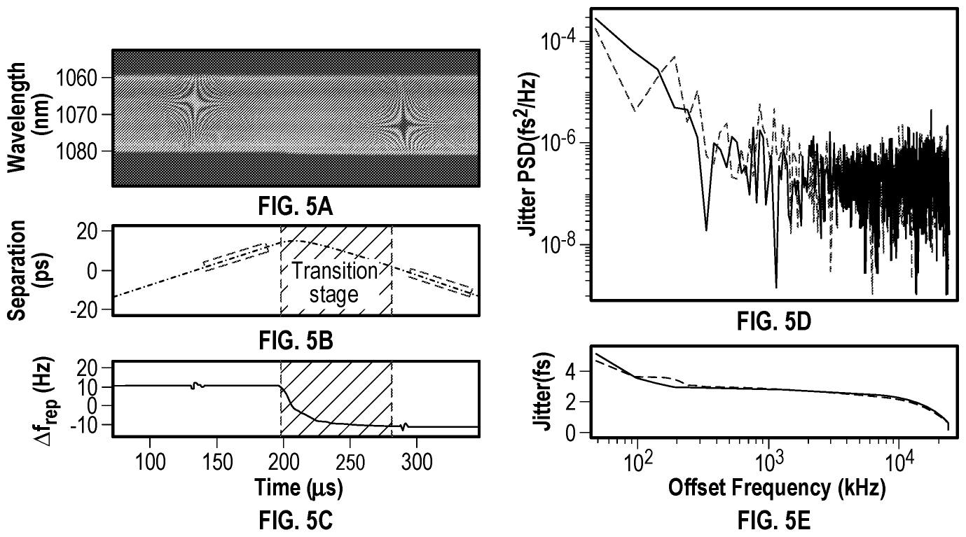

To ensure that the measurement-speed enhancement of DCANDi does not come at the expense of CANDi's timing stability, DFT-based spectral interferometry was used to measure the relative timing jitter during dynamic modulation with fs resolution. Experimental details on the measurement technique can be found in Ref. [26]. FIG. 5A shows the spectral interferogram formed by the two separation-evolving comb pulses. The two positions around 140 μs and 290 μs where the fringe density drops to zero correspond to the times when the two comb pulses meet with each other during the forward and backward scanning. By performing a FFT to the spectral fringes in each roundtrip, the evolution of pulse separation is reconstructed, as shown in FIG. 5B. Furthermore, the corresponding Δfᵣₑₚ may be obtained by taking the derivative of separation evolution in neighboring roundtrips, as shown in FIG. 5C. The local fluctuations at 140 μs and 290 μs were caused by the separation-retrieving error when the two pulses overlap with each other. The near-zero spectral fringe density makes the separation calculation inaccurate. Nevertheless, FIGS. 5B and 5C clearly show the separation and Δfᵣₑₚ evolution during the switching event. As observed, the two pulses first walk off with each other with constant speed before 195 μs. The corresponding Δfᵣₑₚ was about 11 Hz. Then, the pump power dropped, which drove the Δfᵣₑₚ to the negative value. The transition process took around 90 μs, after which the Δfᵣₑₚ appeared stable at −11 Hz. The duration of this transition process is attributed to the laser response bandwidth, which is around 10 kHz. This also set the upper speed limit for the dynamic Δfᵣₑₚ modulation. To verify the laser stability during dynamic operation, the relative timing jitter during 1000 consecutive round trips (48 μs) was calculated before and after the transition stage. The corresponding power spectra densities (PSD) and the integrated jitter are shown in FIGS. 5D and 5E, respectively. As observed, the PSDs for both time spans appear almost identical and the integrated jitter (from 24 MHz to 20 kHz) is only around 5 fs, which is as stable as a conventional CANDi laser without modulation [26]. This result confidently proves that dynamic modulation of Δfᵣₑₚ does not sacrifice relative timing stability, thus providing a powerful technique for significantly enhancing the dual-comb detection speed using a SCDCL.

### 6. Fast, High-Fidelity, Nonlinear Metrology

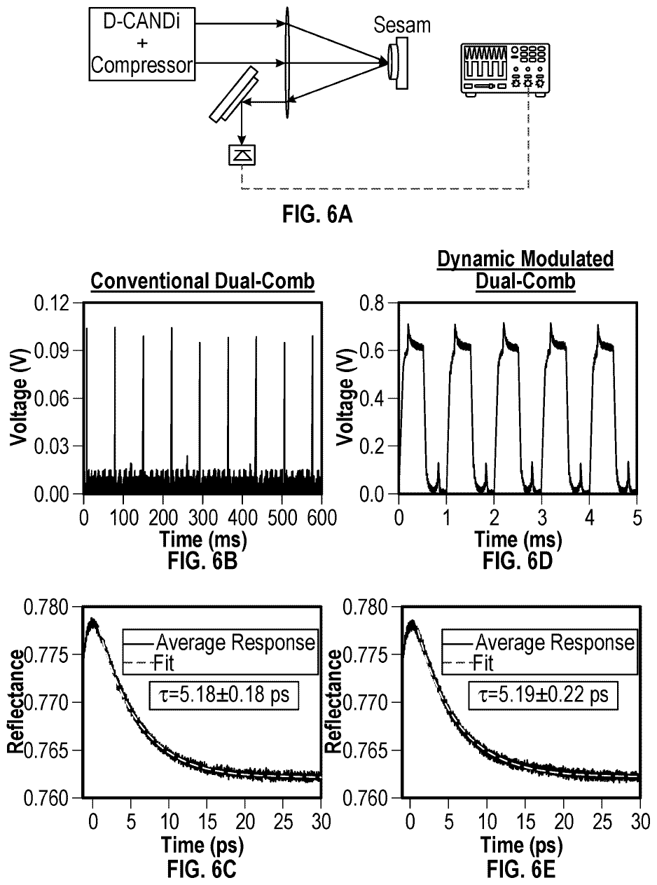

To demonstrate the application of high measurement speed and temporal resolution of the proposed dynamic Δfᵣₑₚ modulation technique, the relaxation time constant of an off-the-shelf SESAM sample (from BATOP) was characterized using DCANDi. The pump fluence incident on the SESAM was 58 μJ/cm² while the probe fluence was 0.5 μJ/cm². The pump-probe experiment was done in a reflection geometry, as shown in FIG. 6A. The reflected probe was collected using a silicon switchable-gain photodetector (THORLABS PDA100A). The relaxation time constant was characterized in both conventional dual-comb pump-probe and the DCANDi methods. The results are shown in FIGS. 6B-6E. In the conventional dual-comb method, where the Δfᵣₑₚ was fixed at 14 Hz (temporal sampling time step is ~6 fs), FIG. 6B shows the collected pump-probe signal for 600 ms (nine pump-probe curves) and FIG. 6C shows the averaged SESAM response which reveals a time constant of τ=5.18±0.18 ps. The same experiment was repeated using dynamic modulation of Δfᵣₑₚ at a frequency of 1 kHz. FIG. 6D shows the measured pump-probe signal using dynamic Δfᵣₑₚ modulation technique for 5 ms. The temporal sampling time step is maintained at ~6 fs. The change in dual-comb level is due to the slight change in output power of the comb due to current modulation. However, this does not affect the signal-to-noise ratio. FIG. 6E shows the average SESAM response, revealing a fitted time constant of τ=5.19±0.22 ps. The number of pump-probe curves used for calculating the average response was kept at nine for both the techniques to ensure the same SNR.

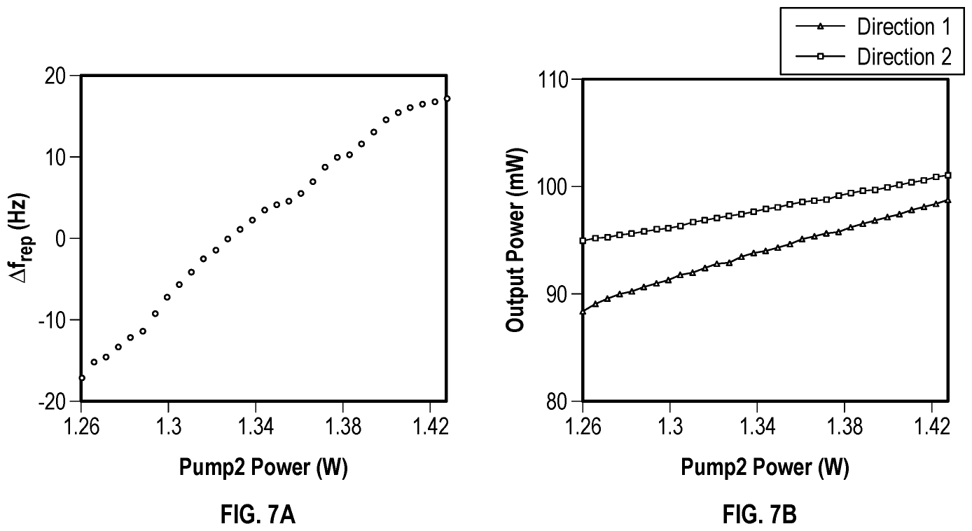

From FIGS. 6B and 6D, it is clear that the measurement speed of the conventional dual-comb technique was 14 Hz while that of DCANDi was 2000 Hz. The 143-fold increase in measurement speed may be further increased by increasing the modulation frequency or reducing Δfᵣₑₚ. In general, the expected measurement-speed enhancement is given by FE=2×f_{mod}/Δfᵣₑₚ, where f_{mod} is the modulation frequency. From FIGS. 6C and 7E, it is also clear that the dynamic switching technique does not compromise measurement accuracy for higher frame rates. Apart from measurement speed enhancement, as a byproduct, assuming the noise is uncorrelated, one can also expect to obtain higher SNR with DCANDi for the same averaging time. From the standard deviation of the fitted response in both cases, it is also clear that DCANDi has a similar error (or SNR) compared to the conventional case. Hence, DCANDi may be used for employing higher measurement speed or higher SNR, depending on the application.

### 7. Materials and Methodologies

Low Bandwidth Locking of Pump1 Power: To ensure that the absolute value of Δfᵣₑₚ is the same before and after flipping, a slow PLL with 100-Hz control bandwidth is applied to Pump1 to lock the time-averaged value of Δfᵣₑₚ to zero. Since the control bandwidth is much smaller than the modulation frequency (i.e., a few kHz), the PLL does not counteract the modulation. To form the PLL, 1% of the output power from both combs are fed into two photodetectors, respectively, to obtain the fundamental repetition-rate frequency, which are then mixed. The output of the mixer serves as the error signal, which is seeded into a proportion-integral-derivative (PID) controller that generates the control signal for controlling the current of pump1. The digital PID controller instrument in Moku:Lab is used for this purpose. Only the proportional and integral options are employed for the PLL loop with an overall gain of +21 dB, proportional gain of 12 dB, and integral gain of 50 dB. These gain settings result in a frequency bandwidth of 100 Hz.

DFT Measurement: The DFT measurement setup includes a 10-km HI1060 fiber spool providing a group delay dispersion of 230 ps², a ytterbium-doped fiber amplifier (YDFA), a fast photodetector with a bandwidth of 12.5 GHz, and a high-speed real-time oscilloscope (10 GHz). The net pulse energy launched into the setup was limited to ~25 pJ to avoid nonlinearity in the fiber.

For measuring the evolution of the pulse spectrum in both directions during the pump power modulation, pulses from each individual direction was sent to the DFT fiber spool alternatively while Pump2 was modulated. For measuring the relative timing jitter of DCANDi, both directions were combined using a 50:50 coupler which has a polarization controller installed in one of the arms to align the polarization of two pulses. One of the output arms of the 50:50 coupler is sent to the DFT fiber spool.

### 8. Experimental Results

### Pulse Compression

Both combs from DCANDi are compressed using a common grating compressor in the transmission geometry. The grating compressor has a transmission of 85%. The compressed pulses were characterized using a conventional FROG setup. The retrieved pulse duration, assuming a Gaussian pulse shape, of comb 1 was about 171 fs while that of comb 2 was 185 fs. The slight difference in pulse duration can be attributed to the slight difference in spectral width and accumulated nonlinear phase along both directions.

### DCANDi Response to Pump Power

The dynamic modulation of Δfᵣₑₚ in DCANDi is realized by modulating the power of one of the pump lasers (Pump2) while keeping the other pump power constant. FIG. 7A shows the response of Δfᵣₑₚ to changes in Pump2 power. Note that the Pump1 power is kept constant at 1.26 W and measurements of Δfᵣₑₚ are obtained using frequency counters. The response is almost linear with a slope of 0.2 Hz/mW and a tuning range of 34 Hz for a power change of 168 mW. These values depends on the mode-locking position as different mode-locking positions may result in different slopes and tuning ranges. Note that for the depicted modelocking state, Δfᵣₑₚ can be further increased by increasing the pump power up to 1.54 W without disturbing the mode locking. Above 1.54 W and below 1.26 W, the bidirectional mode-locking state is disturbed. FIG. 7B shows the corresponding response of the output power in the two directions to changes in the Pump2 power. Direction 2 has smaller slope (0.036 mW/mW) compared to direction 1 (0.062 mW/mW), with an overall change of 6.5% and 11.5%, respectively, in output power for a change of 160 mW pump power. Note that these are the values for the whole tuning range. For a change of Δfᵣₑₚ=10 Hz, the change in output power is lower (3.3% and 5.2%, respectively).

### Response of Pump Power to Square-Wave Modulation

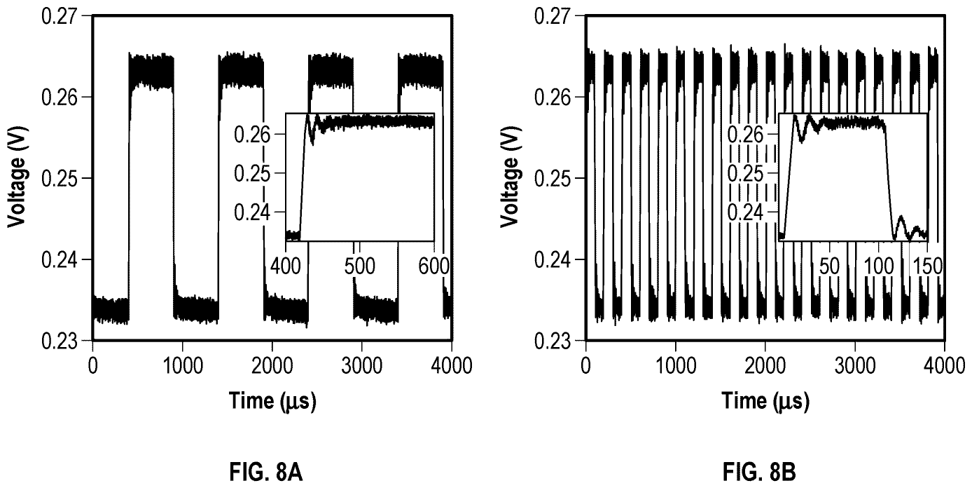

FIGS. 8A and 8B are plots showing the response of the pump power (measured using a photodiode) to square-wave modulation that is applied to the CANDi laser for dynamic modulation of Δfᵣₑₚ. FIGS. 8A and 8B shows the response for a 1-kHz modulation frequency and 5-kHz modulation frequency, respectively. The insets of FIGS. 8A and 8B are expanded views of the first rising edge of the square wave. In both cases, the modulation amplitude is kept constant at 250 mV. The response shows that the pump power follows the modulation wave at least up to 5 kHz. However, the insets reveal that the pump power undergoes an oscillation relaxation-like behavior until ~50 μs, before settling down. This implies that the maximum modulation frequency required to achieve a stable pump power is limited to less than 10 kHz (considering the full period of both high and low of the square wave). This implies a maximum pump-limited frame rate (or half cycle) of 20 kHz in DCANDi. However, as discussed earlier, the maximum frame rate of DCANDi is currently limited by the laser response to ~10 kHz.

### 9. Triggering with Interferograms

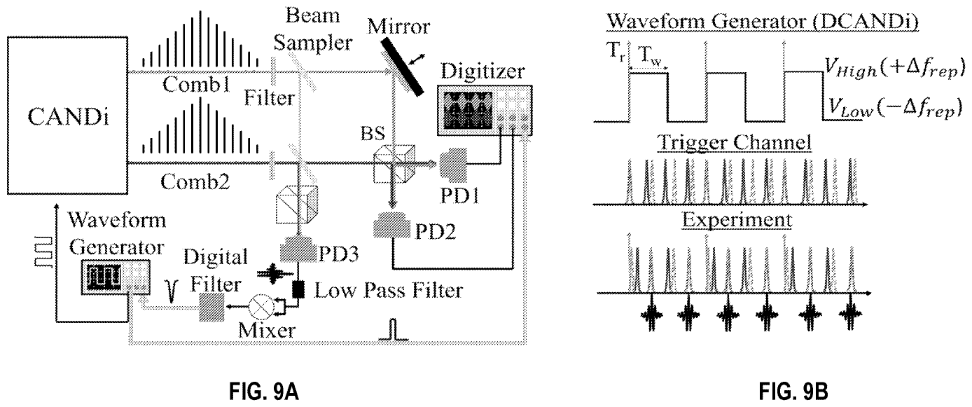

The present embodiments include a method for dynamic scanning based on a trigger signal generated from the interferogram itself. The setup is shown FIG. 9A and the principle is illustrated in FIG. 9B. Like before, a waveform generator modulates the pump power of a CANDi laser (see FIG. 1A). However, instead of operating with a fixed modulation frequency, the waveform generator operates in a burst mode in which it is externally triggered by a signal derived from the interferogram. The interferogram is produced on a beamsplitter (BS) in the beam sampler arm and detected using a photodetector (PD3). The interferogram is low-pass filtered and mixed with itself using a mixer. Using another low-pass filter, the mixer output is filtered to extract the inverted envelope of the interferogram. The inverted envelope is then digitally filtered, which applies gain and a DC offset to the inverted envelope to obtain a voltage sufficient to trigger the waveform generator. The output of the digital filter triggers the waveform generator to generate a single cycle of a square wave.

As shown in FIG. 9B, once the pulses overlap on the trigger arm, an interferogram is generated which, after being processed by the electronics, becomes the trigger signal for the waveform generator. Initially, the waveform generator is placed at the low voltage level V_{Low} (e.g., 0 V), corresponding to a negative repetition-rate difference −Δfᵣₑₚ in DCANDi. When the waveform generator is triggered, the burst mode switches the voltage to a high voltage level V_{High} corresponding to a positive repetition-rate difference +Δfᵣₑₚ. The output of the waveform generator remains at V_{High} for a fixed time window T_{W}. This switches the Pump2 current and triggers the data acquisition. Note that the data acquisition is set such that once the digitizer receives a trigger signal, it collects data for a fixed time. During the duration of T_{W}, the pulses in the trigger arms walk away from each other while the pulses in the experiment walk towards each other. As long as the delay between the experimental signal and trigger arm is <T_{W}, an interferogram event from the experiment is captured within T_{W} and the pulses walk away from each other afterwards. Note that the delay between experiment and trigger arm may be set by adjusting the path length difference in experiment. After T_{W}, the waveform generator switches back to V_{Low} and waits for the next trigger. Once the waveform generator switches to V_{Low}, the direction is reversed and the pulses in both trigger arm and experiment now walk toward each other. By this time, the pulses in the trigger arm would have walked much farther away from each other compared to the pulses in the experiment system. Hence, another interferogram event is obtained before the pulses overlap in the trigger arm to trigger the waveform generator again. This way, two interferograms are captured per modulation period.

### Principles of Dual-Comb Spectroscopy

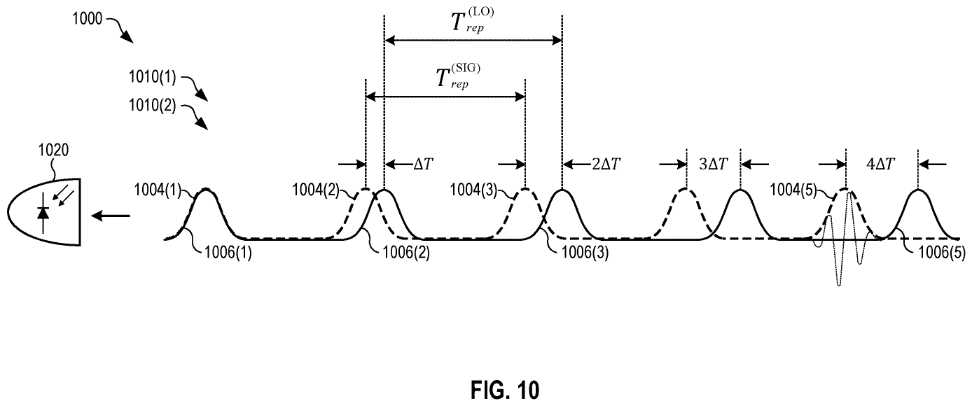

FIG. 10 shows how a double pulse train 1000 is formed by combining a first optical pulse train 1010(1) and a second optical pulse train 1010(2). Since the spectrum of an optical pulse train is a “comb” of equally-spaced frequency components, the first optical pulse train 1010(1) is also referred herein to as a first optical frequency comb. Similarly, the second optical pulse train 1010(2) is also referred to herein as a second optical frequency comb. In the prior art, the first optical pulse train 1010(1) is sometimes referred to as the “local oscillator” (LO) and the second optical pulse train 1010(2) is sometimes referred to as the “signal” (SIG).

The second optical pulse train 1010(2) is formed from a sequence of SIG pulses 1004 that repeat with a repetition period

$${T}_{rep}^{( SIG )} = 1 / {f}_{rep}^{( SIG )} , where {f}_{rep}^{( SIG )}$$

is the repetition rate of the second optical pulse train 1010(2). The first optical pulse train 1010(1) is formed from a sequence of LO pulses 1006 that repeat with a repetition period

$${T}_{rep}^{( LO )} = 1 / {f}_{rep}^{( LO )}$$

that is greater than the repetition period

$${T}_{rep}^{( SIG )}$$

by a difference ΔT that is small compared to both

$${T}_{rep}^{( LO )} and {T}_{rep}^{( SIG )} .$$

### Here

$${f}_{rep}^{( L O )}$$

is the repetition rate of the first optical pulse train 1010(2). The difference ΔT is also smaller t an, or comparable to, a temporal pulse width of each of the SIG pulses 1004 and each of the LO pulses 1006. For clarity in FIG. 2, the first optical pulse train 1010(1) is shown as a solid line while the second optical pulse train 1010(2) is shown as a dashed line.

In FIG. 10, a first SIG pulse 1004(1) and a first LO pulse 1006(1) are detected simultaneously by a photodetector 1020. Due to the difference ΔT of repetition periods, a second LO pulse 1006(2) lags a second SIG pulse 1004(2) by a temporal offset ΔT, a third LO pulse 1006(3) lags a third SIG pulse 1004(3) by a temporal offset 2ΔT, and so on. These time temporal offsets represent times that are “accrued” between the optical pulse trains 1010(1) and 1010(2) as the optical pulse trains 1010(1) and 1010(2) evolve in time. The difference ΔT is also referred to herein as the temporal resolution of dual-comb spectroscopy.

The difference ΔT may be chosen such that

$${T}_{rep}^{( SIG )}$$

is an integer multiple of ΔT, i.e.,

$${T}_{rep}^{( SIG )} = m Δ T$$

for an integer m. Thus, temporal offset, between the m^{th} LO pulse 1006(m) and the corresponding m^{th} SIG pulse 1004(m) is

$${T}_{rep}^{( SIG )} .$$

In this case, the m^{th} LO pulse 1006(m) is detected simultaneously with the (m+1)^{th} SIG pulse 1004(m+1), similar to how the first LO pulse 1006(1) and the first SIG pulse 1004(1) are detected simultaneously in FIG. 10. Equivalently, the double pulse train 1000 is periodic with a period

$${T}_{dpt} = ( m - 1 ) {T}_{rep}^{( LO )} = m {T}_{rep}^{( SIG )}$$

and during one period T_{dpt}, the SIG pulse train 1010(2) generates m SIG pulses 1004 while the LO pulse train 1010(1) generates m−1 LO pulses 1006.

The photodetector 1020 responds to the total intensity of the optical pulse trains 1010(1) and 1010(2) impinging thereon, including cross-terms that arise from interference between the LO pulses 1006 and the SIG pulses 1004. Thus, the photodetector 1020 outputs a photodetector signal that is a measure of the cross-correlation between the optical pulse trains 1010(1) and 1010(2). When an LO pulse 1006 and a SIG pulse 1004 coincide (i.e., have at least some temporal overlap) at the photodetector 1020 (e.g., the first SIG pulse 1004(1) and the first LO pulse 1006(1) in FIG. 10), constructive interference between the LO pulse 1006 and the SIG pulse 1004 may generate a photodetector signal whose magnitude is large. When the LO pulse 1006 and the SIG pulse 1004 do not coincide (i.e., have negligible, if any, temporal overlap) at the photodetector 0220 (e.g., the fifth SIG pulse 1004(5) and the fifth LO pulse 1006(5) in FIG. 10), the lack of interference between the LO pulse 1006 and the SIG pulse 1004 results in a photodetector signal whose magnitude is small.

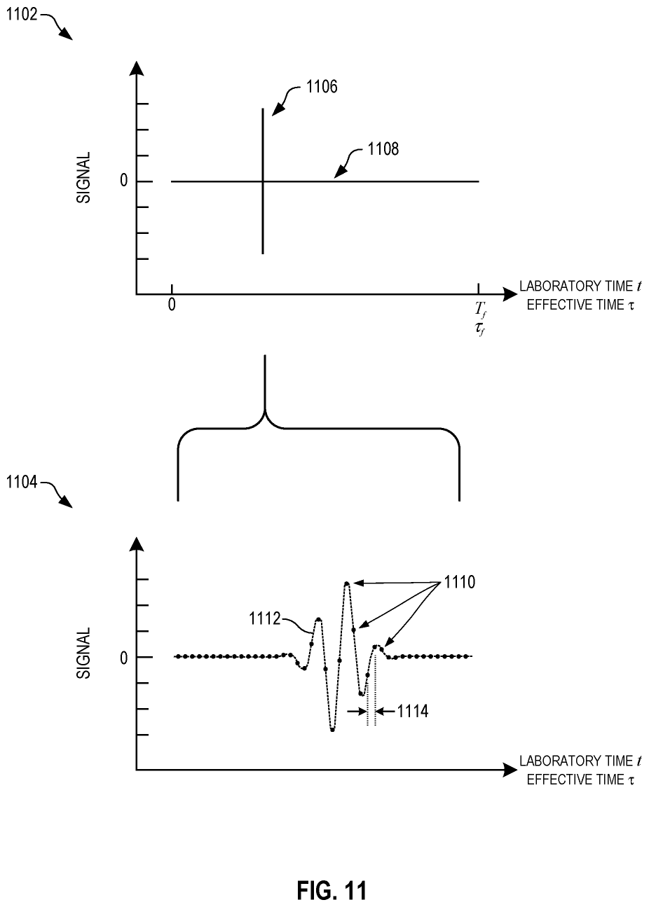

FIG. 11 shows one example of an interferogram 1102 obtained from the photodetector 1020 of FIG. 10. The interferogram 1102 contains m−1 data points 1110 that are obtained by sampling the output of the photodetector 1020 synchronously with m−1 consecutive LO pulses 1006. Thus, in the laboratory frame of reference, the interferogram 1102 is acquired in a frame time

$${T}_{f} = ( m - 1 ) {T}_{rep}^{( LO )} ,$$

which is shown in FIG. 11 relative to an initial time chosen to be zero. The inverse of the frame time T_{f} is also referred to herein as the “detection frame rate,” or simply the “frame rate.” This “laboratory” time is denoted in FIG. 11 by t. Note that the interferogram 1102 contains a signal component 1106 and a noise component 1108 that lacks any non-negligible signal (e.g., has signal-to-noise ratio less than 1).

FIG. 11 also shows an expanded view 1104 of the signal component 1106. In the expanded view 1104, data points 1110 are equally spaced in time by a time step 1114 (also referred to herein as the “dual-comb walk-off step size”). To guide the eye, the data points 1110 are shown in FIG. 11 connected by a dashed line 1112. In laboratory time, the time step 1114 equals

$${T}_{rep}^{( LO )} .$$

However, the time step 1114 also corresponds to the difference, or temporal resolution, ΔT that accrues between LO pulses 1006 and SIG pulses 1004 (see FIG. 10). Thus, the time axis of the interferogram 1102 may be scaled by

$$Δ T / {T}_{rep}^{( LO )}$$

to switch from laboratory time to an “equivalent” time denoted τ. In equivalent time, the interferogram 1102 represents the electric field of the second optical pulse train 1010(2) as sampled by the first optical pulse train 1010(1) with a time spacing of ΔT. Thus, in equivalent time, the interferogram 1102 corresponds to a duration of τ_{f}=(m−1)×ΔT, which is typically several orders of magnitude smaller than the laboratory frame time T_{f}.

In conventional dual-comb spectroscopy, the output of the photodetector 1020 repeats with a period equal to the laboratory frame time T_{f}. As can be seen in FIG. 11, the vast majority of the data points 1110 may contain no useful information about the electric field and therefore are wasted. The reason this occurs is because finer time resolutions (i.e., smaller values of ΔT) cause the number of the data points 1110 to be very high, thereby making the laboratory frame time

$${T}_{f} = ( m - 1 ) {T}_{rep}^{( LO )}$$

very large. Thus, there is a tradeoff between time resolution and the laboratory frame time T_{f}.

As an example of this tradeoff, there may be hundreds of thousands of data points 1110 in the interferogram 1102, of which only a few dozen may contain useful information (e.g., having a signal-to-noise ratio greater than 1). A duty cycle may be defined as the ratio of useful-to-wasted data points within one interferogram. It is common in conventional dual-comb spectroscopy to have duty cycles far less than 1%, meaning that more than 99% of the data points 1110 are wasted. For such low duty cycles, data acquisition is extremely slow.

### Additional Embodiments

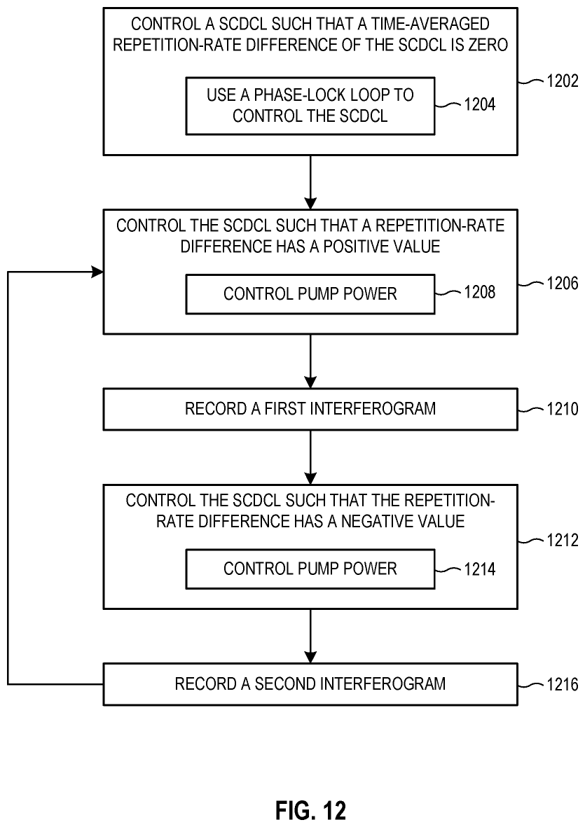

FIG. 12 is a flowchart of a method 1200 for dynamic repetition-rate control of a single-cavity dual-comb laser (SCDCL), in accordance with the present embodiments. The method 1200, which implements the DCANDi technique described herein, may be used to obtain the signal component 1106 of the interferogram 1102 of FIG. 11 without having to acquire all of the noise component 1108. Thus, the method 1200 advantageously speeds up data acquisition by breaking the trade-off between the laboratory frame time T_{f} and the temporal resolution ΔT, as described in the previous section for conventional dual-comb spectroscopy.

In some embodiments, the method 1200 starts with block 1206, in which the SCDCL is controlled such that a repetition-rate difference between first and second pulse trains generated by the SCDCL has a positive value. The first and second pulse trains accrue a first temporal offset while the repetition-rate difference has the positive value. The repetition-rate difference, which is also denoted herein as Δfᵣₑₚ, is also proportional to the inverse of the temporal resolution ΔT described in the previous section. The first temporal offset is an integer multiple of ΔT. Examples of the first pulse train and the second pulse train are shown in FIG. 10 as the first optical pulse train 1010(1) and the second optical pulse train 1010(2), respectively.

The SCDCL may be any type of laser system or coherent light source that generates two optical pulse trains (or optical frequency combs) using one cavity. In the examples described hereinabove, the SCDCL is a bidirectional CANDi fiber laser that mode-locks in both CW and CCW directions at the same time. More generally, the SCDCL may be any type of bidirectional mode-locked laser. Examples of such lasers include fiber-based mode-locked lasers (e.g., the CANDi fiber laser), Kerr-lens mode-locked lasers, and semiconductor disk lasers. Alternatively, the SCDCL may be a microcomb source that uses one microresonator (e.g., a ring microresonator or disk resonator) to create both optical pulse trains. What these examples have in common is that there is one actuator or “knob” that controls the repetition rates of both optical pulse trains such that the repetition-rate difference Δfᵣₑₚ is varied. By contrast, two optical pulse trains may be generated with two independent laser systems, each of which has its own actuator or knob that controls its repetition rate independently of the other laser system (e.g., two separate unidirectional mode-locked lasers).

The method 1200 also includes block 1210, in which a first interferogram is recorded with the first and second pulse trains while the repetition-rate difference has the positive value. The first interferogram may be recorded by performing dual-comb spectroscopy (e.g., pump-probe spectroscopy) on a sample.

The method 1200 also includes block 1212, in which the SCDCL is controlled such that the repetition-rate difference between the first and second pulse trains has a negative value. The first and second pulse trains accrue a second temporal offset while the repetition-rate difference has the negative value. The first and second temporal offsets have the same magnitude and opposite signs.

In some embodiments, the method 1200 further includes block 1216, in which a second interferogram is recorded while the repetition-rate difference has the negative value. In these embodiments, the blocks 1210 and 1216 may have the same duration, i.e., the first interferogram and the second interferogram have the same frame duration. Also in these embodiments, the negative value of the repetition-rate difference and the positive value of the repetition-rate difference may have the same magnitude. The first and second interferograms may be averaged together (e.g., to improve signal-to-noise).

In some embodiments, the method 1200 iterates over the blocks 1206, 1210, and 1212. The method 1200 may also iterate over the block 1216 when included (as shown in FIG. 12). Note that iterating in this fashion is equivalent to frequency modulating the repetition-rate difference. The modulation waveform may be a square wave, in which case one period of the square wave corresponds to a single execution of the blocks 1210 and 1216 (see FIG. 3B). However, another type of modulation waveform may be used, such as a rectangle wave, a triangle wave, a sine wave, or a sawtooth wave. From these various types of modulation, it should be appreciated that the durations of the blocks 1210 and 1216 do not need to be equal.

In embodiments that do not measure the second interferogram, it is still important to wait for the second temporal offset to accrue. Therefore, in these embodiments, the block 1216 may be replaced by a “wait” block in which no step is performed while the second temporal offset is accruing. To speed up this accruing, the negative value of the repetition-rate difference may be set to have a greater magnitude than the first value of the repetition-rate difference.

In some embodiments, the block 1206 includes the block 1208, in which the SCDCL is controlled by varying pump light that pumps the SCDCL. Similarly, the block 1212 includes the block 1214. The pump light may be controlled, for example, by varying current that electrically powers pump diodes (e.g., see Pump1 and Pump2 in FIG. 1A). Alternatively, an optical modulator may be used to vary the power of the pump light coupled into the single laser cavity. As an alternative to the blocks 1208 and 1212, the repetition-rate difference may be controlled by varying intracavity waveplates of the SCDCL (e.g., when the SCDCL is a bidirectional CANDi fiber laser).

In certain embodiments, the method 1200 includes block 1202 in which the SCDCL is controlled such that the positive value of the repetition-rate difference and the negative value of the repetition-rate difference have a time-averaged value of zero. In some of these embodiments, the block 1202 includes block 1204 in which a phase-locked loop is used to control the SCDCL. For example, a portion of the first pulse train may be photodetected to obtain a first beat signal at a first repetition rate of the first pulse train. Similarly, a portion of the second pulse train may be photodetected to obtain a second beat signal at a second repetition rate of the second pulse train. The first and second beat signals may then be mixed together to obtain a difference signal whose frequency is equal to the difference between the first and second repetition rates. The SCDCL may then be controlled, based on the difference signal, in a manner similar to that described above with respect to the blocks 1208 and 1214 (e.g., by controlling pump light).

### Combination of Features

Features described above as well as those claimed below may be combined in various ways without departing from the scope hereof. The following examples illustrate possible, non-limiting combinations of features and embodiments described above. It should be clear that other changes and modifications may be made to the present embodiments without departing from the spirit and scope of this invention:

(A1) A method for dynamic repetition-rate control of a single-cavity dual-comb laser includes controlling the single-cavity dual-comb laser such that a repetition-rate difference between first and second pulse trains generated by the single-cavity dual-comb laser has a positive value. The method also includes recording an interferogram with the first and second pulse trains while the repetition-rate difference has the positive value. The method also includes controlling, after said recording, the single-cavity dual-comb laser such that the repetition-rate difference between the first and second pulse trains has a negative value. The first and second pulse trains accrue a first temporal offset while the repetition-rate difference has the positive value. The first and second pulse trains accrue a second temporal offset while the repetition-rate difference has the negative value. The first temporal offset and the second temporal offset have the same magnitude and opposite signs.

(A2) In the method denoted (A1), the negative value of the repetition-rate difference and the positive value of the repetition-rate difference have the same magnitude.

(A3) In any of the methods denoted (A1) to (A2), the method further includes repeating (i) said controlling the single-cavity dual-comb laser such that the repetition-rate difference has the positive value, (ii) said recording the interferogram, and (iii) said controlling the single-cavity dual-comb laser such that the repetition-rate difference has the negative value.

(A4) In any of the methods denoted (A1) to (A3), said recording includes recording a first interferogram. The method further includes recording a second interferogram while the repetition-rate difference has the negative value.

(A5) In the method denoted (A4), said recording the first interferogram and said recording the second interferogram have the same frame duration.

(A6) In either of the methods denoted (A4) and (A5), the negative value of the repetition-rate difference and the positive value of the repetition-rate difference have the same magnitude.

(A7) In any of the methods denoted (A4) to (A6), the method further includes averaging the first interferogram and the second interferogram.

(A8) In any of the methods denoted (A1) to (A7), said controlling the single-cavity dual-comb laser such that the repetition-rate difference has the positive value includes varying pump light that pumps the single-cavity dual-comb laser. Furthermore, said controlling the single-cavity dual-comb laser such that the repetition-rate difference has the negative value includes varying the pump light.

(A9) In any of the methods denoted (A1) to (A8), the single-cavity dual-comb laser includes a fiber laser.

(A10) In the method denoted (A9), the fiber laser is a counter-propagating all-normal dispersion fiber laser.

(A1 l) In any of the methods denoted (A1) to (A10), the method further includes controlling the single-cavity dual-comb laser such that the positive value of the repetition-rate difference and the negative value of the repetition-rate difference have a time-averaged value of zero.

(A12) In the method denoted (A11), said controlling the single-cavity dual-comb laser such that the positive value of the repetition-rate difference and the negative value of the repetition-rate difference have the time-averaged value of zero includes using a phase-locked loop to control the single-cavity dual-comb laser.

(A13) In the method denoted (A12), said using the phase-locked loop includes detecting a portion of the first pulse train to obtain a first beat signal at a first repetition rate of the first pulse train, detecting a portion of the second pulse train to obtain a second beat signal at a second repetition rate of the second pulse train, mixing the first beat signal and the second beat signal to obtain a difference signal that is equal to a difference between the first repetition rate and the second repetition rate, and controlling the single-cavity dual-comb laser with the difference signal.

(A14) In the method denoted (A13), said controlling the single-cavity dual-comb laser with the difference signal includes controlling a first pump that emits pump light that pumps the single-cavity dual-comb laser, said controlling the single-cavity dual-comb laser such that the repetition-rate difference has the positive value includes controlling a second pump that emits pump light that pumps the single-cavity dual-comb laser, and said controlling the single-cavity dual-comb laser such that the repetition-rate difference has the negative value includes controlling the second pump.

(A15) In any of the methods denoted (A1) to (A14), the method further includes compressing pulses of the first pulse train and compressing pulses of the second pulse train.

(A16) In any of the methods denoted (A1) to (A15), said recording the interferogram comprises performing spectroscopy.

(A17) In the method denoted (A16), said performing spectroscopy comprises performing pump-probe spectroscopy.

(A18) In any of the methods denoted (A1) to (A17), said recording the interferogram comprises performing asynchronous optical sampling.

(A19) In any of the methods denoted (A1) to (A18), said recording the interferogram comprises performing dual-comb laser ranging.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

### REFERENCES

[1] A. M. Weiner. John Wiley & Sons, 2011.
[2] T. Yasui, R. Ichikawa, Y.-D. Hsieh, K. Hayashi, H. Cahyadi, F. Hindle, Y. Sakaguchi, T. Iwata, Y. Mizutani, H. Yamamoto. Sci. Rep. 2015, 5 (1), 10786.
[3] G. Hu, T. Mizuguchi, R. Oe, K. Nitta, X. Zhao, T. Minamikawa, T. Li, Z. Zheng, T. Yasui. Sci. Rep. 2018, 8 (1), 1-9.
[4] R. D. Baker, N. T. Yardimci, Y.-H. Ou, K. Kieu, M. Jarrahi. Sci. Rep. 2018, 8 (1), 1-8.
[5] J. Pupeikis, W. Hu, B. Willenberg, M. Mehendale, G. A. Antonelli, C. R. Phillips, U. Keller. Photoacoustics 2023, 29, 100439.
[6] J. Pupeikis, B. Willenberg, F. Bruno, M. Hettich, A. Nussbaum-Lapping, M. Golling, C. P. Bauer, S. L. Camenzind, A. Benayad, P. Camy. Opt. Express 2021, 29 (22), 35735-35754.
[7] Q. Wang, Z. Wang, H. Zhang, S. Jiang, Y. Wang, W. Jin, W. Ren. Nat. Commun. 2022, 13 (1), 2181.
[8] B. Lomsadze, B. C. Smith, S. T. Cundiff. Nat. Photonics 2018, 12 (11), 676-680.
[9] B. Lomsadze, S. T. Cundiff. IEEE Photonics Technol. Lett. 2019, 31 (23), 1886-1889.
[10] K. J. Mohler, B. J. Bohn, M. Yan, G. Mélen, T. W. Hansch, N. Picqué. Opt. Lett. 2017, 42 (2), 318-321.
[11] R. Kameyama, S. Takizawa, K. Hiramatsu, K. Goda. ACS Photonics 2020, 8 (4), 975-981.
[12] T. Ideguchi, S. Holzner, B. Bernhardt, G. Guelachvili, N. Picque, T. W. Hänsch. Nature 2013, 502 (7471), 355-358.
[13] Y. Zhang, M. Lu, T. Wu, K. Chen, Y. Feng, W. Wang, Y. Li, H. Wei. ACS Photonics 2022, 9 (4), 1385-1394.
[14] Q.-F. Yang, X. Yi, K. Y. Yang, K. Vahala. Nat. Photonics 2017, 11 (9), 560.
[15] T. Ideguchi, T. Nakamura, Y. Kobayashi, K. Goda. Optica 2016, 3 (7), 748-753.
[16] S. M. Link, D. Maas, D. Waldburger, U. Keller. Science (80-.). 2017, 356 (6343), 1164-1168.
[17] G. Hu, Y. Pan, X. Zhao, S. Yin, M. Zhang, Z. Zheng. Opt. Lett. 2017, 42 (23), 4942-4945.
[18] X. Zhao, T. Li, Y. Liu, Q. Li, Z. Zheng. Photonics Res. 2018, 6 (9), 853-857.
[19] R. Li, H. Shi, H. Tian, Y. Li, B. Liu, Y. Song, M. Hu. Opt. Express 2018, 26 (22), 28302-28311.
[20] K. Kieu, M. Mansuripur. Opt. Lett. 2008, 33 (1), 64-66.
[21] K. Zhao, H. Jia, P. Wang, J. Guo, X. Xiao, C. Yang. Opt. Lett. 2019, 44 (17), 4323-4326.
[22] Y. Nakajima, Y. Hata, K. Minoshima. Opt. Express 2019, 27 (5), 5931-5944.
[23] C. Zhang, F. Qu, P. Ou, H. Sun, S. He, B. Fu. In Photonics; MDPI, 2023; Vol. 10, p 221.
[24] J. Yang, X. Zhao, L. Zhang, Z. Zheng. Front. Phys. 2023, 10, 1070284.
[25] B. Li, J. Xing, D. Kwon, Y. Xie, N. Prakash, J. Kim, S.-W. Huang. Optica 2020, 7 (8), 961-964.
[26] N. Prakash, S.-W. Huang, B. Li. Optica 2022, 9 (7), 717-723.
[27] E. D. Caldwell, L. C. Sinclair, N. R. Newbury, J.-D. Deschenes. Nature 2022, 610 (7933), 667-673.
[28] Y. Shi, D. Hu, R. Xue, Z. Wu, J. Dong, H. Tian, C. Wang, J. Wang, M. Hu, Y. Song. Opt. Express 2022, 30 (5), 8391-8398

What is claimed is:

1. A method for dynamic repetition-rate control of a single-cavity dual-comb laser, comprising:
controlling the single-cavity dual-comb laser such that a repetition-rate difference between first and second pulse trains generated by the single-cavity dual-comb laser has a positive value;
recording an interferogram with the first and second pulse trains while the repetition-rate difference has the positive value; and
controlling, after said recording, the single-cavity dual-comb laser such that the repetition-rate difference between the first and second pulse trains has a negative value;
wherein:
the first and second pulse trains accrue a first temporal offset while the repetition-rate difference has the positive value;
the first and second pulse trains accrue a second temporal offset while the repetition-rate difference has the negative value; and
the first temporal offset and the second temporal offset have the same magnitude and opposite signs.

2. The method of claim 1, wherein the negative value of the repetition-rate difference and the positive value of the repetition-rate difference have the same magnitude.

3. The method of claim 1, further comprising repeating (i) said controlling the single-cavity dual-comb laser such that the repetition-rate difference has the positive value, (ii) said recording the interferogram, and (iii) said controlling the single-cavity dual-comb laser such that the repetition-rate difference has the negative value.

4. The method of claim 1, wherein:
said recording comprises recording a first interferogram; and
the method further comprises recording a second interferogram while the repetition-rate difference has the negative value.

5. The method of claim 4, wherein said recording the first interferogram and said recording the second interferogram have the same frame duration.

6. The method of claim 4, wherein the negative value of the repetition-rate difference and the positive value of the repetition-rate difference have the same magnitude.

7. The method of claim 4, further comprising averaging the first interferogram and the second interferogram.

8. The method of claim 1, wherein:
said controlling the single-cavity dual-comb laser such that the repetition-rate difference has the positive value comprises varying pump light that pumps the single-cavity dual-comb laser; and
said controlling the single-cavity dual-comb laser such that the repetition-rate difference has the negative value comprises varying the pump light.

9. The method of claim 1, the single-cavity dual-comb laser comprising a fiber laser.

10. The method of claim 9, the fiber laser comprising a counter-propagating all-normal dispersion fiber laser.

11. The method of claim 1, further comprising controlling the single-cavity dual-comb laser such that the positive value of the repetition-rate difference and the negative value of the repetition-rate difference have a time-averaged value of zero.

12. The method of claim 11, wherein said controlling the single-cavity dual-comb laser such that the positive value of the repetition-rate difference and the negative value of the repetition-rate difference have the time-averaged value of zero comprises using a phase-locked loop to control the single-cavity dual-comb laser.

13. The method of claim 12, wherein said using the phase-locked loop comprises:
detecting a portion of the first pulse train to obtain a first beat signal at a first repetition rate of the first pulse train;
detecting a portion of the second pulse train to obtain a second beat signal at a second repetition rate of the second pulse train;
mixing the first beat signal and the second beat signal to obtain a difference signal that is equal to a difference between the first repetition rate and the second repetition rate; and
controlling the single-cavity dual-comb laser with the difference signal.

14. The method of claim 13, wherein:
said controlling the single-cavity dual-comb laser with the difference signal comprises controlling a first pump that emits pump light that pumps the single-cavity dual-comb laser;
said controlling the single-cavity dual-comb laser such that the repetition-rate difference has the positive value comprises controlling a second pump that emits pump light that pumps the single-cavity dual-comb laser; and
said controlling the single-cavity dual-comb laser such that the repetition-rate difference has the negative value comprises controlling the second pump.

15. The method of claim 1, further comprising:
compressing pulses of the first pulse train; and
compressing pulses of the second pulse train.

16. The method of claim 1, wherein said recording the interferogram comprises performing spectroscopy.

17. The method of claim 16, wherein said performing spectroscopy comprises performing pump-probe spectroscopy.

18. The method of claim 1, wherein said recording the interferogram comprises performing asynchronous optical sampling.

19. The method of claim 1, wherein said recording the interferogram comprises performing dual-comb laser ranging.
